(19) United States
(12) Patent Application Publication
(10) Pub. No.: US 2024/0125679 A1
(43) Pub. Date: Apr. 18, 2024

(54) Apparatus and process for embedding a histological sample in an embedding material

(71) Applicant: Inpeco SA, Novazzano (CH)

(72) Inventors: Gianandrea PEDRAZZINI, Novazzano (CH); Andrea GARBARINO, Novazzano (CH); Flavio BELLANDO, Novazzano (CH)

(21) Appl. No.: 18/485,611

(22) Filed: Oct. 12, 2023

(30) Foreign Application Priority Data
Oct. 13, 2022 (IT) 102022000021159

(51) Int. Cl. G01N 1/36

(52) U.S. Cl. CPC G01N 1/36; G01N 2001/366

(57) ABSTRACT

An apparatus for processing a histological sample to be embedded in an embedding material includes a dispensing system for dispensing different layers of embedding material in a liquid state, which includes: a containment tank for receiving solid grains of embedding material, a hopper for gradually conveying the material embedding within the tank, a heated container arranged to receive material in a solid state conveyed by the hopper and to melt the solid grains making the embedding material in the liquid state, a dispensing device operatively connected to the container, arranged to regulate outflow of liquid material to be poured within a containment group containing the histological sample. The tank, hopper and container are connected to each other in cascade, so that limited quantities of embedding material received in the solid state from the hopper are gradually melted in the heated container, compared to a total quantity introduced within the tank.

### FIELD OF THE INVENTION

The present invention generally concerns an apparatus and process for processing a histological sample in the embedding step. More particularly, the present invention relates to a dispensing system of embedding material arranged to dispense different layers of embedding material in the liquid state.

In the field of anatomical pathology, the embedding step of a histological tissue in an embedding material (typically paraffin) is performed after a surgical sample taken from a patient has undergone cutting (“grossing”), formalin fixation and a treatment (“processing”) in which the tissue sample is dehydrated in alcohol and then clarified with xylene, so as to transform the tissue itself from hydrophilic to hydrophobic, in order to proceed with a first impregnation in paraffin.

### PRIOR ART

Document JP6383625B2 describes a system to automatically perform the embedding operation of a histological sample in an embedding material.

According to a per se known technique, in the aforementioned grossing step, the biological tissue is inserted into a histology cassette, within which it is while it undergoes the aforementioned processing operation, to be then directed towards the subsequent embedding step. An example of a conventional histology cassette is illustrated in FIG. 1A of the annexed drawings. With reference to this figure, the number 1 indicates the assembly of a cassette 2 and a lid 3. In a typical example, the body of the cassette 2, made of plastic material, is in the form of a relatively flat container, with a flat bottom wall 4 and two pairs of opposite walls defining a containment cavity for the histological sample, which can be closed with the lid 3. The bottom wall 4 of the cassette 2 is shaped like a grid, for reasons that will become clear in the following.

According to a conventional process, which is performed manually, before carrying out the embedding procedure an operator separates the lid 3 of the cassette 2, takes the histological sample from the cassette 2 with the aid of a clamp and places it on the bottom of a mould intended to receive the embedding material, and eventually already arranged with a first layer of embedding material (typically paraffin at a temperature sufficient to keep it in a fluid state). The mould can be constituted, for example, of plastic or metallic material and can have a bottom of dimensions which vary according to the sample to be received.

FIG. 1B of the annexed drawings illustrates some examples of moulds 5 of a conventional type. The moulds 5 are configured and sized to receive the body of a cassette 2 above them. Indeed, after the histological sample has been positioned on the bottom of a mould 5, the cassette 2 (separated from the lid 3) is applied on top of the mould 5, forming a containment group G as illustrated in FIG. 1C. Still with reference to FIG. 1B, it can be seen that, although the external dimensions of each mould 5 are chosen in such a way as to allow the application of the body of the cassette over the mould, each mould 5 has a bottom cavity 6, intended to receive the histological sample, which varies in size from mould to mould, depending on the histological sample to be received.

According to the conventional procedure, the operator pours a first layer of embedding material on the bottom 6 of a mould 5 and then inserts the histological sample taken from a cassette on the bottom 6 of the mould 5. This step is extremely critical to ensure a high reliability of the examination that is subsequently performed on the sample. In fact, the operator must pay attention to place the histological sample on the bottom of the mould with the most appropriate orientation in order to guarantee the best results in the next microtomy step, in which the sample embedded in a block of embedding material is subjected to the cut.

Once the operator has placed the histological sample on the bottom of the mould 5, orienting it in the most appropriate way, he applies the cassette 2 above the mould 5.

Once this operation has been performed, the operator places the mould 5 containing the histological sample, with the cassette 2 applied above it, under a dispensing tap of embedding material (typically paraffin) maintained at a temperature sufficient to leave it in a fluid state. In this step, the embedding material is poured by gravity into the mould 5, making it pass through openings of the bottom wall 4 of the cassette 2. Fluid is poured in sufficient quantity to fill the mould and the containment space of the cassette above the mould.

Once the mould 5 has been filled with embedding material, it must be subjected to cooling to solidify the embedding material. At that point, the solidified body of the embedding material, with the histological sample embedded therein, is separated from the mould 5 for further manipulation. The body of the cassette 2 remains joined to the solidified body.

With reference to the dispensing step of the embedding material in the liquid state, a typically adopted solution involves a heated tank into which the solid embedding material is poured in grains, to be melted thanks to the heat generated in the tank. The heated tank has a considerable capacity, for example on the order of 2 liters, so that it can receive a considerable volume of embedding material which is then liquefied within the tank. The embedding material in the liquid state is then used in small doses through a dispensing tap, doses on the order of about 6 grams for each containment group G.

This solution, however, is not without drawbacks.

First, such a solution involves a considerable energy consumption to heat the entire volume of the tank, having to bring all the inserted embedding material to a liquid state.

Secondly, in the event of a failure of the dispensing tap—for example due to a control valve remaining permanently in the open position—all the liquid embedding material is lost, thus pouring the entire paraffin content onto other eventual moving parts in the system, and thus having to start again with the melting operations of a large quantity of embedding material.

In addition, the initialization time of the process is particularly long, as it is necessary to melt a large quantity of solid material before starting with dispensing.

Moreover, it is necessary to keep all the paraffin in temperature with possible problems of denaturation, i.e. chemical alterations of the paraffin due to maintaining the paraffin at high temperatures for an extended time.

These drawbacks are also particularly critical in the context of an automated processing and anatomical pathology system that does not involve the manual interaction of an operator.

### OBJECT OF THE INVENTION

The object of the present invention is to solve the above-mentioned drawbacks.

In particular, it is an object of the present invention to realize an apparatus and process for dispensing different layers of embedding material in the liquid state, which allows the efficiency and reliability of the result to be greatly increased, compared with conventional techniques.

A further object of the invention is to achieve all of the above purposes with relatively simple and low-cost means.

### SUMMARY OF THE INVENTION

In view of achieving one or more of the above objects, the invention relates to an apparatus for processing a histological sample to be embedded in an embedding material, comprising a dispensing system of embedding material arranged to dispense different layers of embedding material in the liquid state, wherein said dispensing system comprises:
a containment tank for receiving solid grains of embedding material,
at least one hopper operatively connected to said containment tank configured to gradually convey the material poured within the containment tank,
at least one heated container operatively connected to the hopper by means of at least one connection duct, wherein the heated container comprises heating means arranged to heat the volume of the heated container at a temperature useful for melting the material received in a solid state from the hopper, so that the heated container is arranged to receive material still in a solid state conveyed by the hopper and to melt the solid grains making the gradually received embedding material in the liquid state,
at least one dispensing device operatively connected to the heated container, arranged to automatically regulate the outflow of liquid material to be poured within a containment group containing a histological sample,
wherein the containment tank, the hopper and the heated container are connected to each other in cascade, so that limited quantities of embedding material received in the solid state from the hopper are gradually melted in the heated container, compared to the total quantity introduced within the containment tank.

It is also an object of the present invention the process that is implemented by means of the apparatus described above.

Further advantageous features of the invention are defined in the appended claims and description below.

### BRIEF DESCRIPTION OF FIGURES

Further features and advantages of the invention will result from the following description with reference to the appended drawings, provided purely by way of non-limiting example, in which:

FIG. 1A is a perspective view of a histology cassette of a known type, which can also be used in the apparatus according to the invention,

FIG. 1B shows a series of moulds of a known type which can also be used with the apparatus according to the invention,

FIG. 1C is a perspective view of a cassette applied over a mould, according to a configuration which can also be used in the apparatus according to the invention,

FIG. 2 is a perspective view illustrating some features of a dispensing system of embedding material, according to an embodiment of the invention,

FIG. 3 is a section view showing an unheated upper portion of the system of the previous figure,

FIG. 4 is a further section view illustrating a heated lower portion of the system shown in FIG. 2,

FIG. 5 is a further section view of the components illustrated in the previous figure, according to a different section plane, and

FIG. 6 is a further section view of the heated lower portion, according to a further section plane.

### DETAILED DESCRIPTION OF MULTIPLE EMBODIMENTS

The following description illustrates various specific details aimed at a deep understanding of examples of one or more embodiments. Embodiments may be realized without one or more of the specific details, or with other methods, components, materials, etc. In other cases, known structures, materials or operations are not shown or described in detail to avoid obscuring various aspects of the embodiments. Reference to “an embodiment” within this description indicates that a particular configuration, structure or feature described according to the embodiment is included in at least one embodiment. Thus, sentences such as “in an embodiment”, possibly occurring in different points in this description, do not necessarily refer to the same embodiment. In addition, particular conformations, structures or features may be appropriately combined in one or more embodiments and/or associated to the embodiments in a different way than illustrated here, so that for example a feature exemplified here according to a figure may be applied to one or more embodiments exemplified in a different figure.

References illustrated herein are for convenience only and therefore do not limit the scope of protection or the extent of the embodiments.

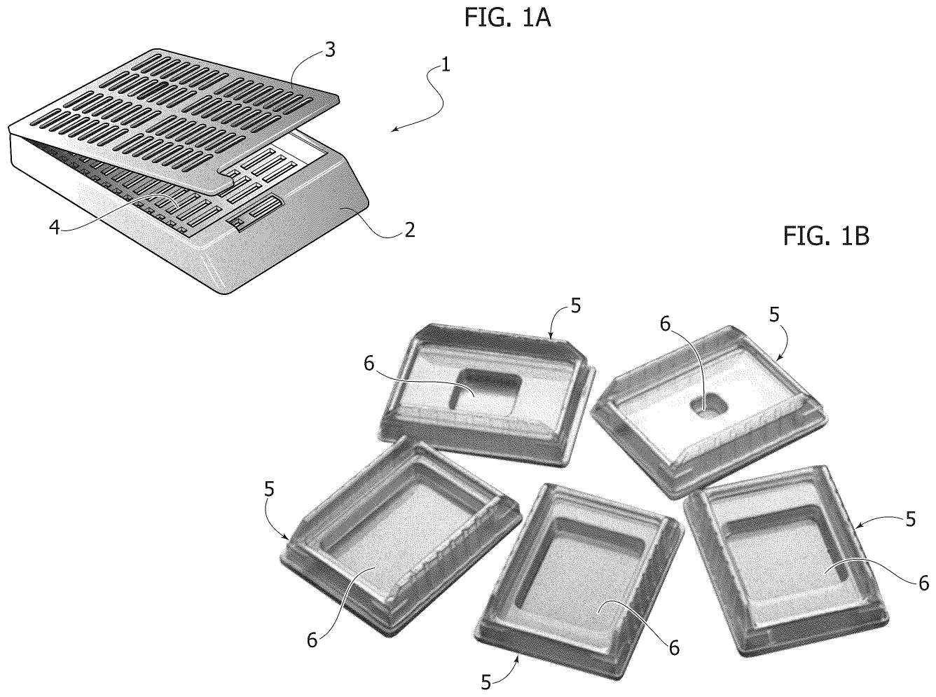

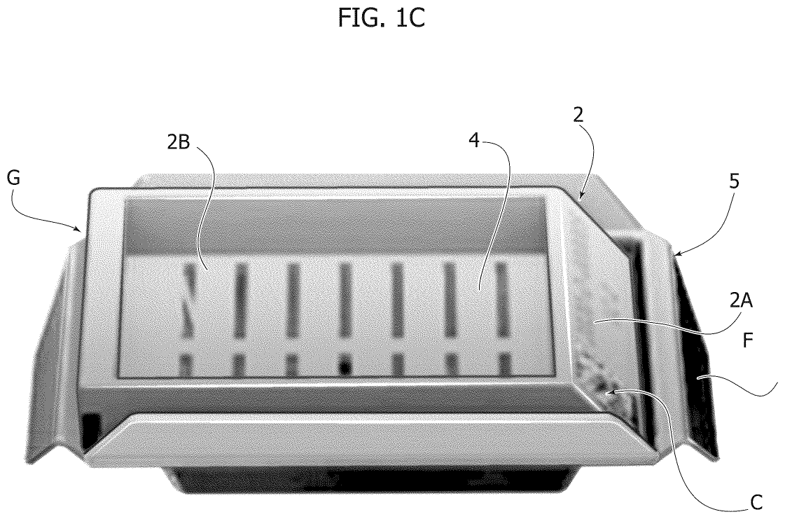

The present invention relates to an apparatus for embedding a histological sample in an embedding material, comprising a dispensing system 8 of embedding material, arranged to dispense different layers of embedding material in the liquid state. As indicated at the beginning of this description, the different layers of liquid material can be dispensed in a containment group G (set of a mould 5 and cassette 2) according to respective steps of a process for embedding a histological sample in the embedding material. More specifically, a first layer of embedding material (typically paraffin) is dispensed at the bottom of a respective mould 5, after the histological sample has been placed at the bottom of the mould 5 (e.g. by means of an operator). Following the dispensing of the first layer, a cassette 2 is placed over the mould 5, in order to obtain a containment group G as shown in FIG. 1C. A second layer of embedding material is dispensed on the containment group G (formed by mould 5 and cassette 2) as explained in more detail below.

In one or more embodiments, the apparatus is fully automated so that the histological sample and the embedding material can be processed without manual operations performed by an operator.

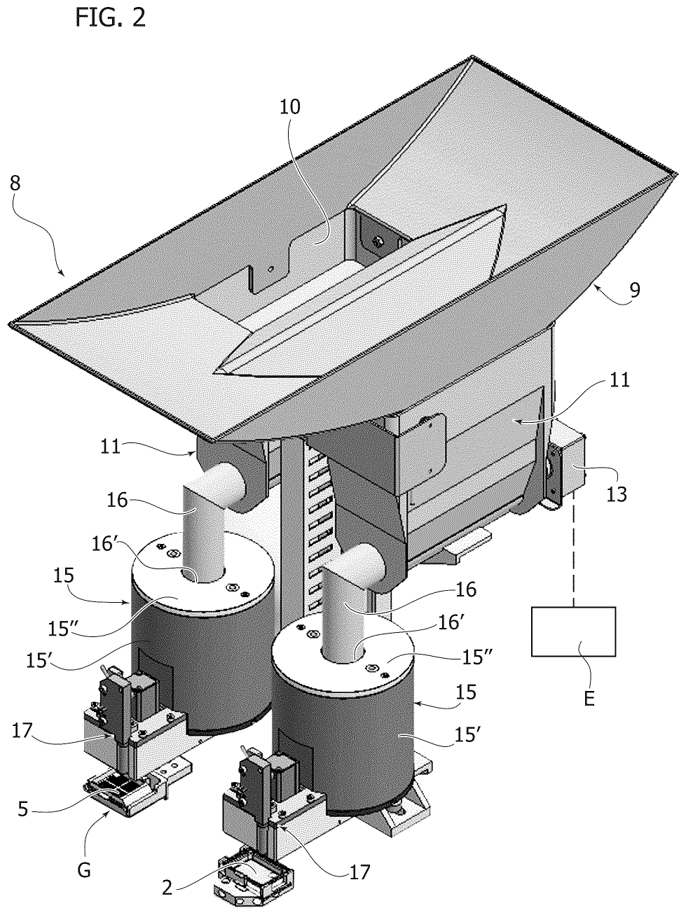

FIG. 2 shows the part of the apparatus related only to the dispensing system 8. However, the dispensing system 8 is intended to be integrated within an automation system that can work continuously to carry out various processing operations on embedding material, before and after the dispensing step of layers of embedding material.

In this regard, Italian patent application No. 102021000013757 filed by the same Applicant, and which forms part of the state of the art under Article 46(3) of the Italian Industrial Property Code, describes additional parts of the automation system, before or after the dispensing step.

With reference to process operations before the dispensing step, the apparatus may comprise a bench on which an input area is defined that is configured to receive from a transport system cassettes 2 containing histological samples. Automated transport systems are provided upstream and downstream of the apparatus. The transport system which is arranged upstream feeds cassettes 2 containing histological samples to be analyzed, while the transport system downstream of the apparatus feeds histological samples, each embedded in a body of embedding material, to the next station of an automated sample processing line. Preferably, such systems are made according to what is described in the Italian patent application No. 102021000009788 by the same Applicant. The construction details of the transport systems are not described here, both as they can be made in any known way, and as they, taken alone, do not fall within the scope of the present invention. It should be noted that the upstream and downstream transport systems, in a less preferable and not illustrated embodiment, can also be manual.

The apparatus includes an electronic controller E (shown only schematically in FIG. 2). The electronic controller E is configured and programmed to control the automated devices of the apparatus, including the dispensing system 8, and to possibly assist an operator working in a working area.

The apparatus further comprises a manipulator device of any known type, arranged to pick up the cassettes received in the input area and to lay them, if necessary, in an accumulation area provided with a system to maintain the cassettes in an illustrated temperature range. The manipulator device can be a robot of any known type preferably having a movable head along three mutually orthogonal axes X, Y, Z.

In one or more embodiments, the working area, where there may be an operator, receives only one cassette at a time sequentially. Only when the cycle of operations to be performed in the working area on a particular cassette 2 is over, the system enables the feeding to the working area of a new cassette. When the signal indicating the completion of the cycle of operations performed on cassette 2 that is in the working area is received by the electronic controller E, the latter controls the manipulator device to pick up a given cassette from the accumulation area and feed it to the working area. The electronic controller E can be configured and programmed to perform a selection (“sorting”) of the cassette to be picked up.

In one or more embodiments, in the working area, an operator manually performs the necessary operations to arrange a histological sample within a respective mould 5, orienting it appropriately. Each time a cassette 2 reaches the working area, the operator picks up the sample and lays it on the bottom of a respective mould 5 after having preliminarily poured on the bottom of the mould 5 a first layer of embedding material (typically paraffin) through a dispensing station. The operator applies the cassette 2 over the mould 5 and places the resulting group G on a transfer device to transport the group towards a further step in the process. FIG. 1C of the attached drawings shows the result of the above operations. Each containment group G comprises a mould 5 on whose bottom 6 there is the first layer of embedding material dispensed by the dispensing station, in which the operator has placed and then oriented the histological sample. The body of the cassette 2 is applied over the mould 5 as a lid. Thus, the mould 5 and the body of the cassette 2 have dimensions suitable for this purpose. The body of the cassette 2 defines a cavity 2B intended to be filled with liquid embedding material, whose bottom wall 4 has through openings, in order to allow the passage of the embedding material that is poured through the cavity 2B within the mould 5 below. The inclined end surface 2A of the body of the cassette 2, remains in a position exposed to view. Preferably, the cassette 2 comprises an information carrier C, which may be a code of any known type (such as a bar code) but in the example is a QR code. Even the mould may include its own information carrier F. Due to these features, it is achieved in the process and apparatus according to the invention the advantage of continuous traceability of each processed sample, which allows to associate the sample with identifying information related to it during the whole course of operations performed in the apparatus.

The transfer device brings the mould 5 containing the histological sample with the body of the cassette 2 applied over it to near the dispensing system 8.

The following description shows the peculiar features of the dispensing system 8 of embedding material, arranged to dispense the above-mentioned layers of embedding material in the liquid state. The liquid material is dispensed after a melting step of solid state material introduced at the beginning of the process.

Referring to the perspective view of FIG. 2, according to the present invention the dispensing system 8 comprises a containment tank 9 configured to receive solid grains of embedding material, later to be melted. The containment tank 9 is only arranged to contain and convey the solid grains of embedding material towards a lower portion of the system 8, downstream of the tank 9, which allows to melt and dispense the embedding material in an automated manner. The tank 9 comprises an upper opening 10 for inserting the grains. The grains are conveyed by gravity within the tank 9, towards the aforementioned lower portion of system 8. The tank 9 is not provided with heating means to heat its volume, as it is only arranged to convey the solid grains later to be melted.

Still with reference to FIG. 2, the dispensing system 8 comprises at least one hopper 11 operatively connected to the containment tank 9, at a lower end thereof opposite to the upper opening 10.

The hopper 11 is configured to gradually convey the previously poured solid material into the containment tank 9. Each hopper 11 comprises a screw conveyor 12 arranged on a bottom portion of the hopper 11, and transversely extended with respect to the vertical spacing of the tank 9 and the hopper 11. The screw conveyor 12 is controlled in rotation by a respective motor 13, in order to convey the solid grains to a further step of the process.

According to a preferred embodiment illustrated in the appended drawings, the dispensing system 8 comprises two hoppers 11 operating in parallel and both connected to the containment tank 9. Preferably, the dispensing system 8 has a total capacity of a grain quantity of about 3.5 kg, while each hopper 11 can contain about 600 g of embedding material.

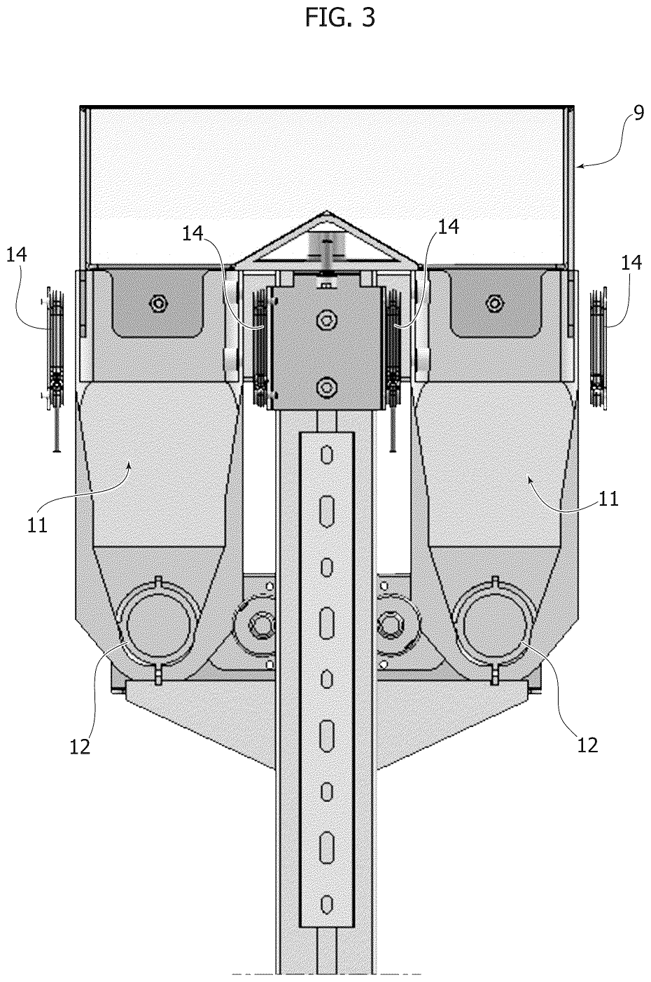

FIG. 3 illustrates a section view of a part of the system 8, specifically of hoppers 11. In that figure, reference 14 shows a plurality of photocell sensors to verify the level of remaining grains in the hoppers 11. According to the specific configuration illustrated in FIG. 3, each hopper 11 has a photocell sensor 14 on each side, so that two pairs of sensors 14 are made. Each pair of sensors 14 is configured to verify the level of remaining grains in the respective hopper 11. In the event that one of the sensors activates, the electronic controller E receives a signal to be transmitted to an operator, i.e. by means of a human-machine interface device, which communicates the need to refill the upper containment tank 9 with grains of embedding material (paraffin).

The operating principle of the hopper 11 is to drop limited quantities of solid grains down to a heated lower portion of the system 8, so that the same quantity of liquid material available for dispensing is maintained at all times, with the minimum thermal shock. Thus, it should be noted that the hopper 11 does not provide any heating means to melt the material received from the tank 9.

Downstream of the hopper 11, the dispensing system 8 comprises at least one heated container 15 operatively connected to the hopper 11 by means of at least one connection duct 16. The heated container 15 is configured to receive the material conveyed from the hopper 11 and to melt the gradually received embedding material. The containment tank 9, the hopper 11 and the heated container 15 are then cascaded together, so that limited quantities of embedding material are gradually melted in the heated container 15, with respect to the total quantity introduced in the containment tank 9.

The heated container 15 comprises heating means to constantly maintain the container 15 at a temperature between about 65° C. and 75° C., so as to prevent the embedding material from solidifying along the way to the final dispensing. It should be noted that the aforementioned upper temperature limit is due to the fact that the histological samples degrade at a temperature above 75° C.

According to a further feature, the heated container 15 has a smaller volume than that of the containment tank 9 and the hopper 11, and more specifically the volume of the container 15 is equal to or less than 5-10% of the sum of the volumes of the tank 9 and the hopper 11. As a result of this feature, in the event of failures of the system 8—for example due to a control valve remaining permanently in the open position—only a portion of the total quantity of material included in the tank is dispersed, in particular the already melted material collected in the container 15.

In one or more embodiments, the heated container 15 is a container of cylindrical shape defining a side wall 15′, an upper wall 15″ and a bottom wall 15′″. The upper wall 15″ has a central opening 16′ connected to an end portion of the connection duct 16, to receive the solid grains from the hopper 11.

In view of the above, the heated container 15 is a container operating as a boiler, arranged to melt the solid material coming from the hopper 11, making the liquid material available for final dispensing. To perform the final dispensing, the dispensing system 8 also comprises a dispensing device 17 connected to the heated container 15, to dispense the previously melted liquid material within the heated container 15. Details of the dispensing device 17 and the dispensing step are given later in this description.

Referring to a preferred embodiment illustrated in the drawings, the dispensing system 8 comprises two parallel heated containers 15, each connected to a respective hopper 11 in communication with the containment tank 9. In the embodiment illustrated in the drawings, each heated container 15 comprises a respective dispensing device 17, so as to parallelize the dispensing of different layers of embedding material. According to an alternative embodiment not illustrated, the dispensing system 8 comprises a single heated container 15 to which two dispensing devices 17 are connected, still to parallelize the dispensing of different layers of embedding material.

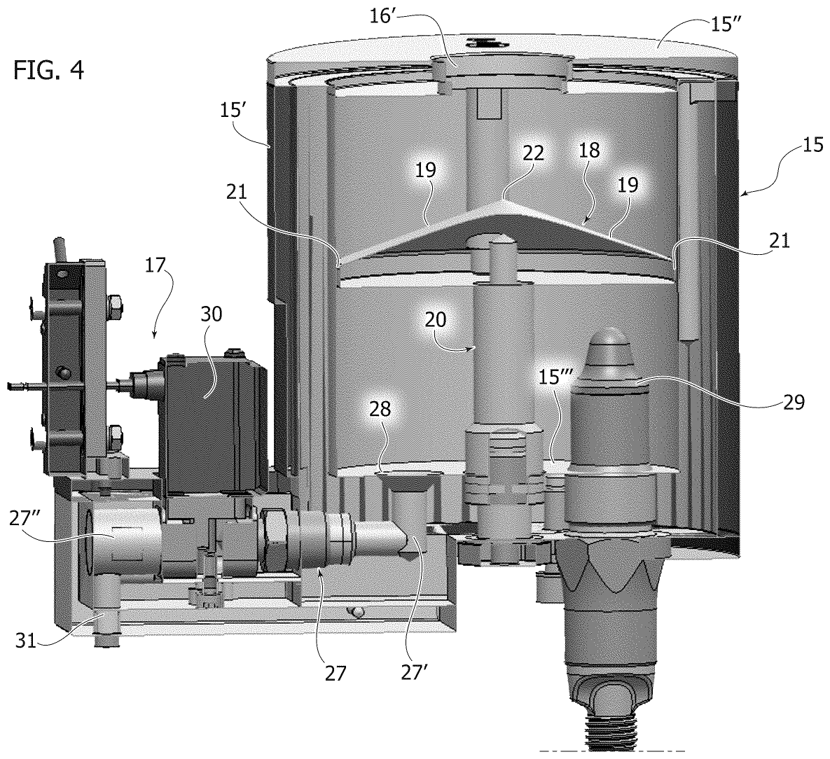

FIG. 4 shows a section view of the heated container 15 and the dispensing device 17. Inside the heated container 15 there is a heated area 18 for melting the solid grains. The heated area 18 comprises a heated surface 19 arranged to receive by gravity the solid material from the upper opening 16′, and to melt the material thus deposited on the surface 19. Still with reference to FIG. 4, the heated area 18 is spaced within the container 15 at an intermediate height between the top wall 15″ and the bottom wall 15′″, with a base circumference of slightly smaller diameter than that of the container 15. The heated area 18 is supported at the aforementioned intermediate height by a support rod 20 vertically extended within the container 15 from the bottom wall 15′″. In other words, the heated area 18 and the support rod 20 form an umbrella-like configuration, since the support rod 20 bears the heated area 18 which has an extension substantially covering the volume of container 15 below the heated area 18, preventing the direct fall of the material from the upper opening 16′ towards the bottom wall 15′″.

According to a peculiar feature, within the heated container 15 there is a peripheral free space 21 obtained between the inner surface of the side wall 15′ of the heated container 15 and the perimeter of the heated area 18. Such a free space 21 is obtained with the function of letting flow the material melted by the heated area 18, towards the bottom wall 15′″ of the heated container 15. In this regard, the heated surface 19 has an inclined shape so as to direct the liquid material from a central area of the heated surface 19, towards the peripheral free space 21. According to a preferred embodiment, the heated surface 19 has a conical shape with two sides sloping in opposite directions, joined at a central upper vertex 22. Alternatively, still to allow the outflow of liquid material towards the free space 21, the heated surface 19 may have a shape of the spherical cap type. The free space 21 between the base circumference of the heated area 18 and the inner surface of the side wall 15′ of the container 15 is in the order of 1 mm. This size allows liquid paraffin to flow, but also allows impurities to be retained, so that the umbrella structure also acts as a filter to retain impurities.

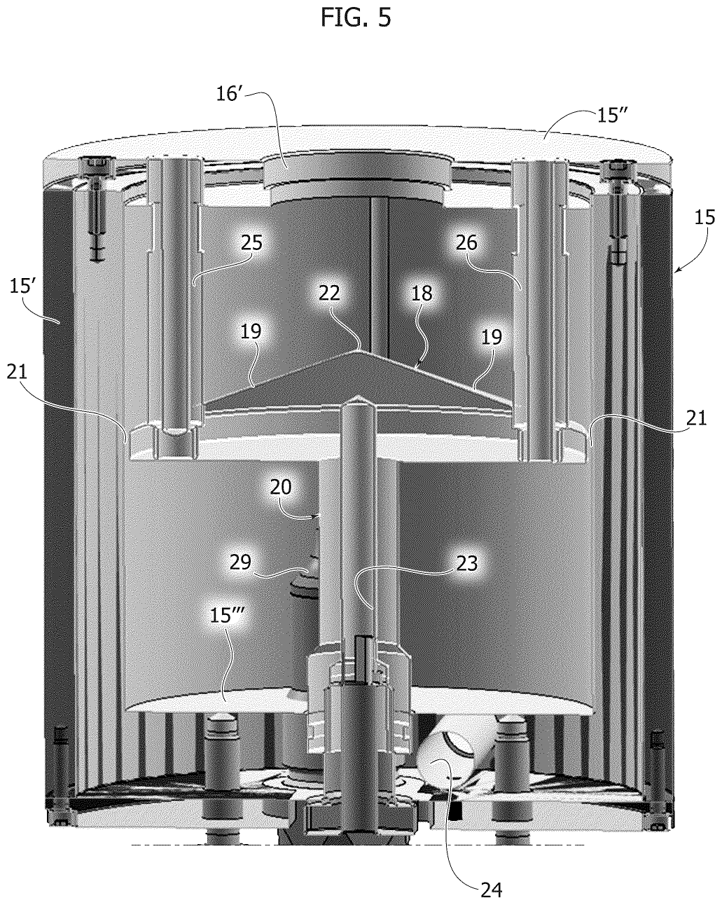

As previously indicated, the heated container 15 comprises heating means to reach the temperature necessary to melt the solid grains received through the upper opening 16′. FIG. 5 illustrates further features of the container 15, also in this regard.

Reference 23 indicates an axial housing included within the support rod 20 to include a first heating resistance able to heat the heated surface 19 on which the solid material settles. Reference 24 indicates a further housing extended below the bottom wall 15′″, to include a second heating resistance able to heat the structure of the container 15.

References 25, 26 indicate respective vertical channels obtained between the upper wall 15″ of the heated container 15 and the heated surface 19, respectively arranged to house a temperature sensor (to measure the temperature reached within the container 15) and a vent duct for the passage of air. It should be noted that the aforementioned temperature sensor is useful for constantly monitoring the reached temperature, so as to ensure a correct process free from anomalies due to incorrect temperature ranges.

As previously indicated, the dispensing system 8 includes a dispensing device 17 to dispense the previously melted liquid material within the heated container 15. Returning to the section view of FIG. 4, the dispensing device 17 is operatively connected to the heated container 15 by means of a dispensing duct 27. The dispensing duct 27 has a proximal portion 27′ connected to a bottom opening 28 obtained on the bottom wall 15′″ of the heated container 15. Consequently, the liquid material fallen by gravity on the bottom wall 15′″, through the aforementioned peripheral free space 21, is made flow within the duct 27 through the bottom opening 28. The dispensing duct 27 also comprises a distal portion 27″ connected to the dispensing device 17. Reference 29 indicates a level sensor for measuring the level of liquid material deposited on the bottom of the container 15. The sensor is operatively connected to the electronic controller E to transmit a signal related to the level of accumulated liquid material, so as to consequently control the operation of the hopper 11.

The dispensing device 17 comprises an automatic adjustment device for automatically adjusting the outflow of liquid material. The adjustment device comprises a solenoid valve 30 and a dispensing tap 31. The tap 31 is controlled by the solenoid valve 30 which is controlled by the electronic controller E on the basis of a feedback signal sent by a sensor associated to the dispensing device 17. The sensor is able to detect the level of the embedding material, and can be an optical sensor of any known type, for example operating in reflection, able to measure the distance of the sensor itself with respect to the free surface of the fluid of embedding material poured into the group G or the mould 5. The signal emitted by the sensor can also be displayed on a monitor in the form of a numerical indication of the distance between the sensor and the free surface of the embedding material. During the dispensing step, the distance progressively decreases until a predetermined value is reached, corresponding to the correct quantity of embedding material, which is predetermined according to the size of the cassette 2 and the mould 5 arranged below the cassette 2. The electronic controller E is therefore able to close the solenoid valve 30 which controls the dispensing of embedding material and consequently stop the dispensing of the material upon reaching a correct quantity. The electronic controller E during this dispensing operation takes into account, through a specific algorithm, the information already previously possessed on the volume occupied by the histological sample within the mould 5, as well as on the size of the bottom of the mould 5 itself, in order to adequately calibrate the dispensing of the appropriate quantity of embedding material to reach the aforementioned predetermined level.

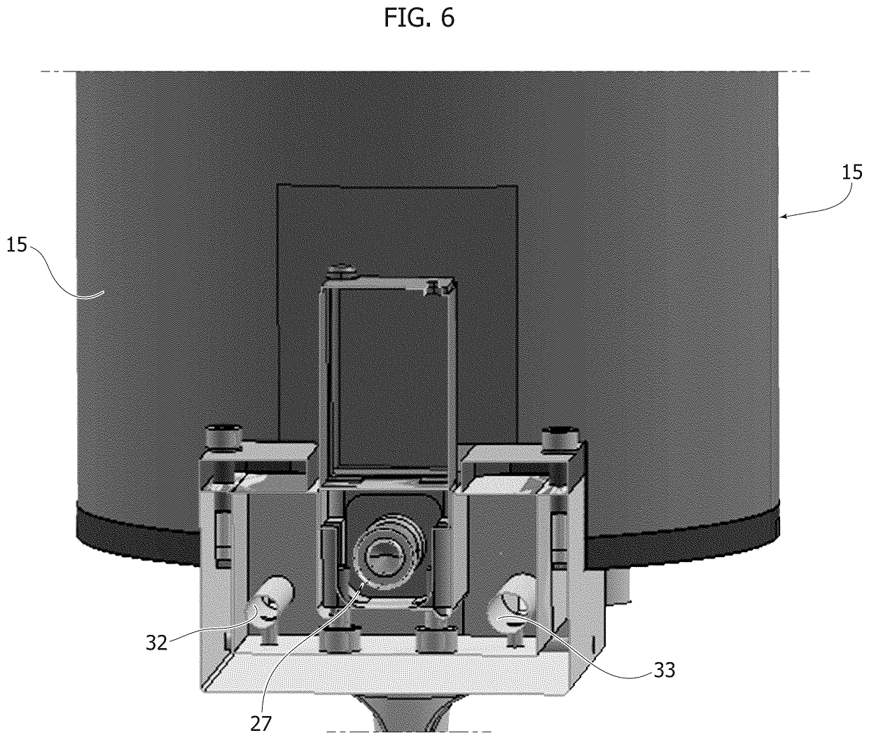

FIG. 6 shows a section view of the connection portion between the dispensing device 17 and the end part of the heated container 15. References 32, 33 respectively indicate a housing for a temperature sensor, to measure the temperature reached in the dispensing duct 27, and a housing for a further heating resistance, to heat the duct 27 so as to prevent the paraffin from solidifying along the way towards the dispensing tap 31.

As mentioned, the dispensing of the embedding material is carried out in a controlled and precise manner, as the system 8 includes a sensor able to detect the level of embedding material within the mould 5 or the group G, assisted by an algorithm able to calibrate the dispensing on the basis of a series of parameters known to the electronic controller E. The moulds 5 are located in a position below the dispensing tap 31 (FIG. 2), to receive a flow of embedding material, which is therefore at a temperature useful to keep it in a fluid state.

As previously indicated, in an alternative preferred embodiment, two dispensing devices 17 can be connected to a single heated container to parallelize the dispensing of different layers of embedding material.

Thanks to the previously described features, the present invention provides for the melting of limited quantities of embedding material necessary for the continuous production of a limited number of paraffin blocks, avoiding the melting at the same time of large quantities which are then used within a period of one or more days depending on laboratory requests. All this results in avoiding possible problems of paraffin denaturation, i.e. chemical alterations of paraffin due to the preservation of paraffin at high temperatures for an extended time.

To carry out operations following the step of melting and dispensing of the embedding material, the apparatus can further comprise a cooling system arranged to cool the containment groups G each containing the histological sample and the embedding material in the liquid state, previously dispensed by means of the dispensing system 8.

To perform steps after cooling, the apparatus can further comprise a device for the detachment of the solidified material from the respective cooled mould. A transport device can provide for feeding the solidified material including the histological sample to the output or to an accumulation area. In one or more embodiments the apparatus comprises an automatic output transport system to feed the moulds, from which the embedding material in the solid state has been detached, through a cleaning station to remove the residues of the embedding material and then convey them back to a feeding system of the moulds in the working area.

Naturally, without prejudice to the principle of the invention, the construction details and the embodiments may vary widely with respect to what is described and illustrated purely by way of example, without thereby departing from the scope of the present invention, as defined in the appended claims.

1. An apparatus for processing a histological sample to be embedded in an embedding material, comprising a dispensing system of embedding material arranged to dispense different layers of embedding material in a liquid state, wherein said dispensing system comprises:
a containment tank for receiving solid grains of embedding material,
at least one hopper operatively connected to said containment tank and configured to gradually convey the embedding material poured within the containment tank,
at least one heated container operatively connected to the at least one hopper by means of at least one connection duct, wherein the at least one heated container comprises heating means arranged to heat a volume of the at least one heated container at a temperature useful for melting the embedding material received in a solid state from the at least one hopper, so that the at least one heated container is arranged to receive material still in the solid state conveyed by the at least one hopper and to melt the solid grains making embedding material in the liquid state, and
at least one dispensing device operatively connected to the at least one heated container, arranged to automatically regulate an outflow of liquid material to be poured within a containment group containing the histological sample,
wherein the containment tank, the at least one hopper and the at least one heated container are connected to each other in cascade, so that limited quantities of embedding material received in the solid state from the at least one hopper are gradually melted in the at least one heated container, compared to a total quantity introduced within the containment tank.

2. The apparatus according to claim 1, wherein said dispensing system comprises an electronic controller configured and programmed to control multiple dispensing processes, and wherein said dispensing system is integrated within an automation system configured to work continuously and to connect different processes on the embedding material, before and after operations performed with the dispensing system.

3. The apparatus according to claim 1, wherein within the at least one heated container there is a heated area for melting the solid grains, wherein the heated area comprises a heated surface arranged to receive by gravity the solid rains from an upper opening in communication with the at least one hopper, and to melt the solid grains thus deposited on the heated surface.

4. The apparatus according to claim 3, wherein the heated area has an extension substantially covering a volume of the at least one container below the heated area, preventing a direct fall of the solid grains from the upper opening towards a bottom wall of the at least one heated container.

5. The apparatus according to claim 4, wherein within the at least one heated container there is a peripheral free space obtained between a side surface of the at least one heated container and a perimeter of the heated area, wherein said peripheral free space is obtained with a function of making the solid grains melted on the heated surface pass, towards the bottom of the heated container, and wherein the heated surface has an inclined shape so as to direct the liquid material from a central area of the heated surface, towards the peripheral free space.

6. The apparatus according to claim 5, wherein the heated area is supported within the at least one heated container spaced above the bottom wall, by at least one support rod vertically extending within the at least one container from the bottom wall, such that the heated area and the support rod form an umbrella configuration covering the volume of the at least one container below the heated area, preventing the direct fall of material coming from the at least one hopper onto the bottom wall.

7. The apparatus according to claim 6, wherein the heated surface has a general substantially conical shape with two sides sloping in opposite directions joined at a central upper vertex, or a general shape of a spherical cap.

8. The apparatus according to claim 5, wherein the dispensing device is operatively connected to the at least one heated container by means of a dispensing duct, and wherein the dispensing duct has a proximal portion connected to a bottom opening obtained on the bottom wall of the at least one heated container.

9. The apparatus according to claim 2, wherein the dispensing device comprises an automatic adjustment device for automatically adjusting the outflow of liquid material, including a solenoid valve and a dispensing tap, and wherein the dispensing tap is controlled by the solenoid valve which is controlled by the electronic controller on a basis of a feedback signal sent by a level sensor for measuring the level of liquid material deposited on the bottom of the at least one heated container.

10. The apparatus according to claim 9, wherein the electronic controller is configured and programmed to take into account, during a dispensing operation, information previously acquired on a volume occupied by the histological sample within a mould, and on a size of a bottom of the mould, in order to adequately calibrate dispensing of a quantity of embedding material to reach a predetermined level.

11. The apparatus according to claim 8, wherein said heating means comprise a first heating resistance configured to heat the heated surface on which the solid grains of embedding material is deposited, a second heating resistance configured to heat the structure of the at least one heated container, and a further heating resistance to heat the dispensing duct.

12. The apparatus according to claim 1, wherein the dispensing system comprises two heated containers operating in parallel and connected in parallel to the containment tank by means of a respective hopper, and wherein each of the two heated containers comprises a respective dispensing device, so as to parallelize the dispensing of different layers of embedding material.

13. The apparatus according to claim 1, wherein the dispensing system comprises a single heated container to which two dispensing devices are connected, to parallelize the dispensing of different layers of embedding material.

14. The apparatus according to claim 3, wherein the at least one heated container is a container of cylindrical shape defining a side wall, an upper wall and said bottom wall, and wherein the upper wall has said upper opening connected to an end portion of the connection duct, to receive the solid grains from the at least one hopper.

15. A process for embedding a histological sample in an embedding material, wherein a step of dispensing embedding material is provided for dispensing different layers of embedding material in the liquid state, wherein said process comprises the steps of:
setting up an apparatus according to claim 1,
inserting the solid grains of embedding material within the containment tank,
gradually conveying the poured embedding material within the containment tank by means of the at least one hopper,
melting the solid grains of embedding material gradually received from the at least one hopper, by means of said at least one heated container, and
dispensing a layer of embedding material in the liquid state by means of said dispensing device,
so that in the at least one heated container limited quantities of embedding material received in the solid state from the at least one hopper are gradually melted, compared to a total quantity introduced within the containment tank.
